(19) United States
(12) Patent Application Publication
(10) Pub. No.: US 2004/0055695 A1
(43) Pub. Date: Mar. 25, 2004

(54) Polymer coated components and method of coating same

(76) Inventor: L. Keith Rogerson, Isle of Palms, SC (US)

Correspondence Address: DORITY & MANNING, P.A., POST OFFICE BOX 1449, GREENVILLE, SC, 29602-1449, US

(21) Appl. No.: 10/247,801

(22) Filed: Sep. 19, 2002

(51) Int. Cl. B29C 59/00; B32B 31/00

(52) U.S. Cl. 156/212; 156/218; 156/272.2; 156/275.1

(57) ABSTRACT

A reactive polymeric material that can be applied onto a structure is provided. The temperature of the structure can be increased such that the reactive material can chemically bond to the structure. For example, the thin film of reactive polymeric material can be utilized to protectively coat a structure or to bond together two or more structurally dissimilar or structurally similar materials.

### FIELD OF THE INVENTION

The present invention is directed to a process for applying a reactive polymeric material to a component.

### BACKGROUND OF THE INVENTION

When making polymeric structures, it is often desirable to apply a polymeric material for a variety of reasons. For example, it may be desirable to affix together structurally dissimilar materials, such as to incorporate metallic insert structures, provide enhanced structural integrity of the finished product, or provide for additional assembly to the polymeric structure. In addition, polymeric materials may also be desirable for providing protective coatings on various materials.

In certain previous applications, connections between polymeric materials and other dissimilar materials such as metals or dissimilar polymers were not sufficiently strong, thus resulting in a weakness in the finished article. One such need for improvement relates to the attachment of a first polymeric material to a second, structurally dissimilar polymeric material. For instance, a glove box of an automobile typically includes an interior portion made from a hard plastic material, such as polystyrene, and a covering made from a soft plastic foam material. Due to the dissimilarities of these plastic materials, the two portions are typically screwed together to form the glove box. However, such mechanical attachment techniques can often require increased processing time, thereby increasing costs.

In addition, a need for improvement also remains in some circumstances when attaching a polymeric material to a metal. For example, it may be desirable to attach a polymeric material to a metal using an extremely thin layer of interface material. Thin layers of interface material can be useful in a variety of applications. One such application is the general attachment of a thin layer of interface material to a metal part such that the metal part can be bonded to a structurally dissimilar material.

As such, a need currently exists for a method of applying a thin layer of polymeric material to another component, such as a metal part or tube. Moreover, a need also exists for a method of bonding two structurally dissimilar plastics together.

### SUMMARY OF THE INVENTION

The present invention provides a method of applying a polymeric material to a component.

Further, the present invention provides a method of coating a reactive, polymeric material onto a metallic or polymeric component, and a method of bonding together two or more structurally dissimilar materials with a reactive polymeric material.

The present invention also provides a film of reactive polymeric material having a thickness of less than about 0.010 of an inch and various processes for applying the film to a component or part.

The foregoing exemplary aspects of the present invention are achieved by providing a thin film of a reactive, polymeric material that can be coated onto a component. In general, a reactive, polymeric material of the present invention can comprise any material known in the art to be capable of chemically bonding to a metallic component. For instance, the reactive polymeric material can include polyolefins having functional monomers grafted thereto. In one example, the thin film of reactive polymeric material can comprise a thickness of less than about 0.010 of an inch, and in another embodiment, less than about 0.001 of an inch.

In general, the thin film of reactive polymeric material can be utilized in a variety of applications and for a variety of purposes. For instance, the thin film can be coated onto a component, such as a metallic or polymeric component. The polymeric component can be made from any polymeric material used in the art, such as polyolefins (e.g. polypropylene or polyethylene), acrylonitrile butadiene-styrene, polycarbonate, polyvinyl alcohol, polyamides (e.g. nylon), polystyrene, etc. Moreover, metallic components can include, for instance, stainless steel, brass, aluminum, zinc alloys, other metals or alloys, etc. Furthermore, a component of the present invention, whether polymeric or metallic, can comprise any shape or size. For instance, a thin film of reactive, polymeric material can be applied onto the outer surface of a metal tube.

In accordance with the present invention, a thin film of reactive polymeric material can generally be applied to a component in a variety of ways. For example, a component can be maneuvered into contact with a moving sheet of the film of reactive polymeric material. The movement and alignment of the sheet can be partially controlled by guide rollers. Moreover, in some aspects of the invention various devices, such as grooved rollers and pulses of air, can be utilized to help depress the reactive polymeric material onto a structure. In another embodiment, the reactive polymeric material is applied to a structure by extrusion, such as by cross-head extrusion in accordance with the invention.

Regardless of the particular method of application, the temperature of the reactive polymeric material can be increased to a temperature sufficient to activate its bonding properties. For instance, the temperature of the structure can be increased to a temperature between about 400° F. to about 450° F. This increase in temperature can generally be accomplished in a variety of ways. For example, the component can first be heated to a temperature sufficient to activate the bonding properties of the reactive material when contacted therewith. Thereafter, the heated component can be contacted with the reactive material such that a thin film of reactive material becomes chemically bonded to the component.

In general, the application of a thin film of reactive polymeric material of the present invention onto a component can allow a protective coating to be applied to the component. Moreover, the thin film of reactive polymeric material can also be utilized to bond together various components having a variety of shapes and sizes. For example, a thin film of reactive material can be utilized to bond a polymeric component to a metallic component.

In another aspect of the invention, a thin film of reactive polymeric material can be utilized to bond together two or more structurally dissimilar polymeric materials or structurally similar hard polymeric materials, such as polycarbonate or polystyrene. Also, a second, third, or multiple applications of reactive polymeric material, non-reactive material and combinations thereof may be achieved for further strengthening and/or protection of a structure in accordance with the present invention.

Other features and aspects of the present invention are discussed in greater detail below.

### BRIEF DESCRIPTION OF THE DRAWINGS

A full and enabling disclosure of the present invention, including the best mode thereof, directed to one of ordinary skill in the art, is set forth in the specification, which makes reference to the appended drawings, in which:

FIG. 1 is a partial perspective view of a vehicle having a brake line coated with a reactive polymeric material to protect the exemplary brake line;

FIG. 2 is a perspective view of a partially cut-away tube exhibiting the reactive polymeric coating;

FIG. 3 is a cross-sectional side view of a structure being contacted with a film of the reactive polymeric material;

FIG. 4 illustrates a cross-sectional side view of the structure in FIG. 3 in which the structure is being substantially simultaneously coated and attached to a structurally dissimilar component;

FIG. 5 is a side view of one embodiment of the present invention in which a cross-head extruder is applying the reactive polymeric material to a tube;

FIG. 6 is a perspective view of another embodiment of the present invention for applying the film of reactive polymeric material to the tube;

FIG. 7 is a perspective view similar to FIG. 6 in which an additional film of material is being applied to the exemplary tube;

FIG. 8a is a perspective view of a painted structural beam exhibiting scratches in which moisture has invaded beneath edges of the scratched paint to evidence corrosion; and

FIG. 8b is similar to FIG. 8a but the structural beam is coated with the reactive polymeric material to prevent the moisture from permeating beneath the edges of the scratched areas.

### DETAILED DESCRIPTION OF THE INVENTION

Reference now will be made in detail to various aspects of the invention set forth below. It is to be understood by one of ordinary skill in the art that the present discussion concerns exemplary descriptions only and is not intended as limiting the broader aspects of the present invention. In fact, it will be apparent to those skilled in the art that various modifications and variations can be made in the present invention without departing from the scope or spirit of the invention. For instance, features illustrated or described as part of one embodiment, can be used on another embodiment to yield a still further embodiment. Thus, it is intended that the present invention cover such modifications and variations as come within the scope of the appended claims and their equivalents. Other objects, features and aspects of the present invention are disclosed in or are obvious from the following detailed description.

The present invention is generally directed to a method of applying a reactive, polymeric material to a component. In particular, a reactive polymeric material can be provided to bond together structurally dissimilar materials or to protectively coat a material. For instance, it has been discovered that a thin film of reactive polymeric material formed according to the present invention can effectively attach a polymeric material to a structurally dissimilar polymeric material, a structurally similar polymeric material, and/or a metallic material. Moreover, it has also been discovered that a process of the present invention can be utilized to apply a thin film of reactive material to completely coat the outside surfaces of a component, such as a metal tube or glass.

As broadly embodied in the Figures, a reactive polymeric material is applied to a variety of structures and components such as a vehicle brake line, a pipe, and building material such as an I-beam. As shown in the Figures, the reactive polymeric material may be applied to variously shaped elements and in a variety of ways such as by heating the structure to be coated with the polymeric material and then rolling or extruding the polymeric material onto a heated structure. While the Figures illustrate exemplary items that are coated with the reactive polymeric material, it should be understood that the following description of the disclosed embodiments is not intended to limit the present invention to use only on the exemplary items nor limit the subsequent or simultaneous application and attachment of the coated items to another similar or dissimilar item. Accordingly, the present invention is suitable for coating a structure at one point in time and then subsequently reheating the coated structure for attachment to another item without the need for nails, glue, bolts, clamps or the like. Likewise, the present invention envisions substantially simultaneously coating an item and attaching the coated item to a separate surface.

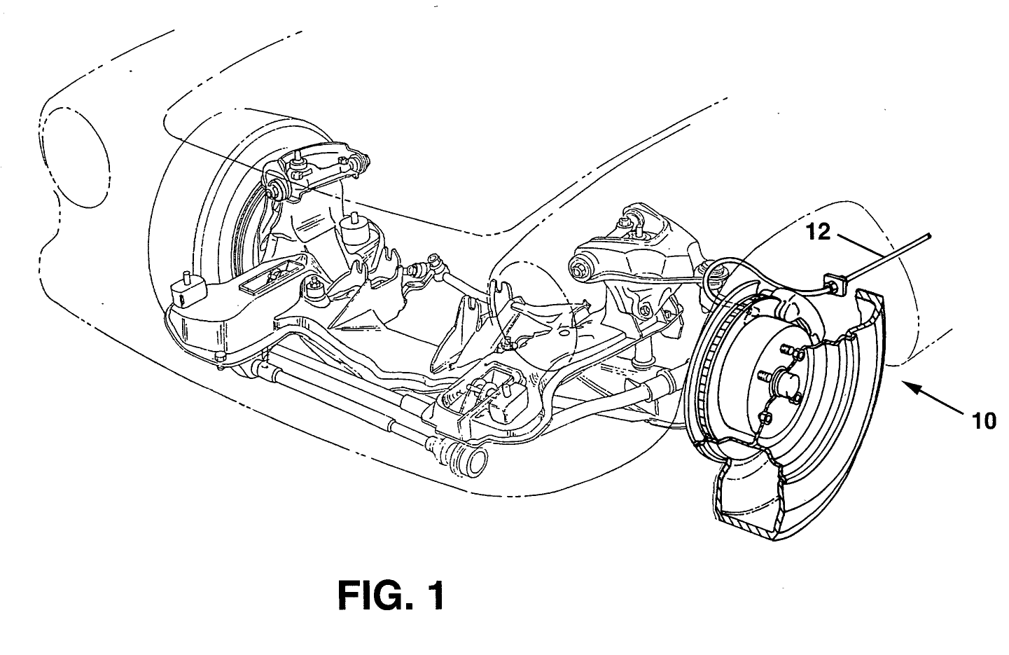

Referring to FIG. 1, applications of a thin film of reactive polymeric material to a component is illustrated. As shown in this partial perspective view of an undercarriage 10 of a vehicle, a reactive polymeric material coated brake line 12 in accordance with the invention is provided. In this example, coated brake line 12 is shielded from, for instance, road salts, other corrosion inducing chemicals and general weather.

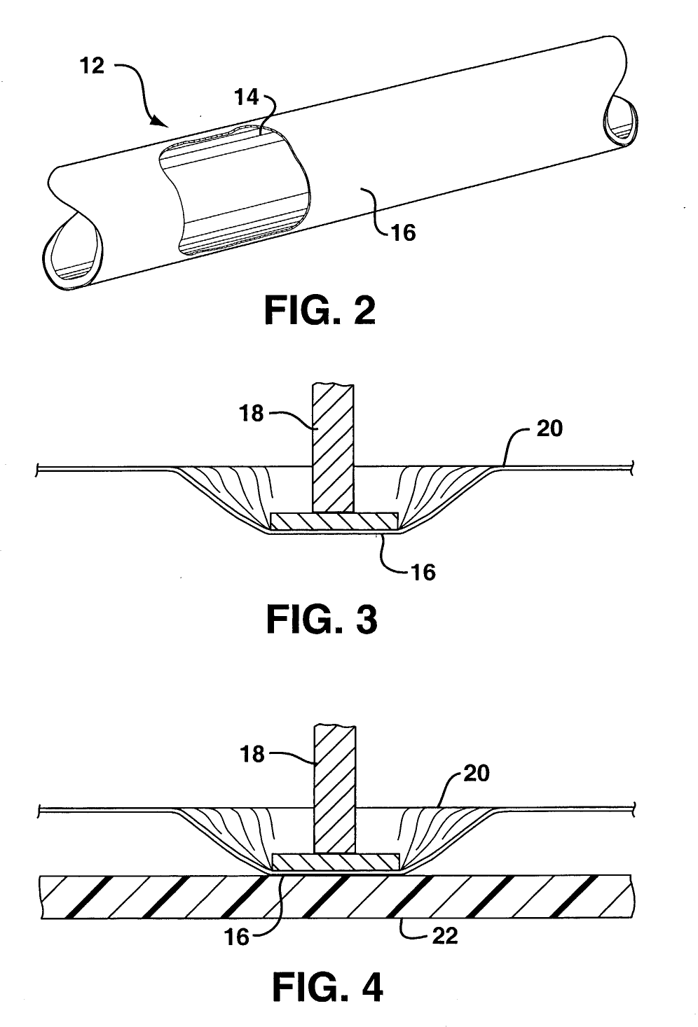

Although component 12 is shown in FIG. 1 as having a tubular shape, it should be understood that such shape is by way of illustration only and that brake line 12 can also have any other shape and a variety of material compositions without affecting the ability of reactive polymeric material 16 (FIG. 2) to be bonded to the part 14. For example, component 12 can be a fastening structure such as a bolt, a screw, a nut, a rivet, a pin, a shaft or threaded insert, a spacer; a structural element such as a beam, a rafter, a truss, a mainstay, a joist, or a girder; and a handle, a computer housing, a telephone, a valve, a boat part, an instrument case, a glass, a hydraulic line, a gas line for a vehicle or fuel farm, etc.

Moreover, component 12 can generally be made from a variety of materials. For example, component 12 can comprise polymeric materials, metallic materials, glass materials and combinations thereof. The polymeric materials can comprise any polymer including, but not limited to, polypropylene, polyethylene, acrylonitrile butadiene-styrene, polycarbonate, polyvinyl alcohol, nylon, polystyrene, polyolefins, polyamides, etc. Metallic components can include, for instance, stainless steel, brass, aluminum, zinc alloys, other metals or alloys, and combinations thereof.

FIG. 2 illustrates that when component 12 has an underlying metallic material such as an uncoated or bare pipe or tube 14, it may be desirable, prior to being coated with reactive polymeric material 16, to provide a low or neutral pH for the surface to be bonded. For instance, in one embodiment, brake line 14 can be maintained at a pH of about 5 by applying a weak acid thereto. Moreover, in some embodiments, brake line 14 can also be cleaned before use by sandblasting or using an acid wash.

According to an aspect of the present invention and as shown in FIGS. 3 and 4, a thin film of reactive polymeric material 20 can generally be used to bond together structurally dissimilar materials, as well as protectively coat various materials. The film of reactive material 20, as illustrated, can be formed to have a thickness less than about 0.010 inches, and in particular, less than about 0.001 inches. In this example, film 20 is being applied to a metal handle 18 in FIG. 3 and subsequently, or simultaneously, to a dissimilar structure 22, such as a plastic tank, in FIG. 4, discussed in more detail below.

The reactive polymeric material of the present invention can generally comprise any material having a capacity to bond to polymeric and/or metallic materials. Examples of such reactive materials are disclosed in U.S. Pat. No. 5,316,810 to Rogerson, which is incorporated herein by reference. In particular, polymers that are suitable for use as a reactive polymeric material of the present invention can include polyolefins having functional monomers grafted thereto.

In some embodiments, the polyolefins may be in homopolymer or copolymer form, such as polyethylenes, polypropylenes, ethylene vinyl acetate and the like, and the functional monomers may be acrylic acid, methacrylic acid, maleic anhydride and the like. Suitable examples of commercially available reactive polymeric materials suitable for use in the present invention include “POLYBOND” products manufactured by BP Performance Polymers, Inc. and “PLEXAR” products manufactured by Quantum Chemical Corporation. It is believed that the bond achieved by such materials is chemical in nature because separation of two dissimilar structures bonded with such a reactive polymeric material occurs across the polymer itself instead of at the polymer-dissimilar material interface. At least one practical result of this bond is that a pull strength in excess of 16,500 ft-lbs is required to pull two bondedly attached structures apart. This advantageously reduces corrosion effects due to scratches and nicks on at least metallic structures, discussed in greater detail below.

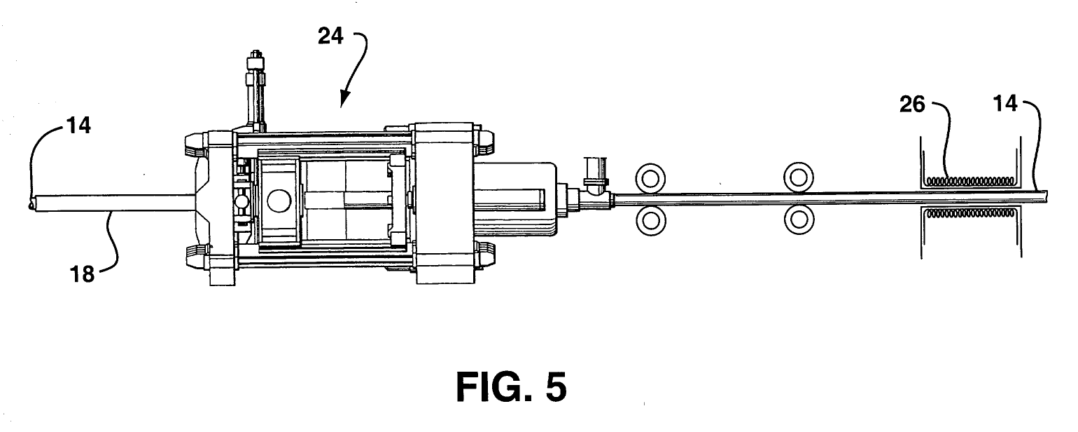

According to another aspect of the present invention as illustrated in FIG. 5, the reactive polymeric material may be provided in the form of pellets or beads (not shown), which can be applied to, for example, pipe 14 by an extruder such as a cross-head extruder 24, discussed in further detail herein.

In order to activate the bonding properties of reactive polymeric material 20 in pellet, film or other form, it is typically necessary to expose the reactive material 20 to a reactive temperature, which is normally a temperature from the melting point of the material 20 to its degradation point. The reactive temperature will vary depending on the particular reactive polymeric material as would be readily apparent to one skilled in the art. For example, the temperature of tube 14 in FIG. 5 can be increased to a temperature from about 400° F. to about 500° F., and in particular to about 425° F. to 450° F., to activate the bonding properties of the reactive material 20.

Depending on the particular application, the reactive temperature can be achieved according to a variety of methods. For example, one method of heating the reactive material 20 can generally include the steps of first heating a component 18 to a certain temperature and thereafter contacting the heated component 18 with the reactive polymeric material 20. Thus, as discussed above and shown in FIGS. 3 and 4, structure 18 can be heated to the reactive temperature of reactive polymeric material 20 prior to contacting it with polymeric material 20. Alternatively, as shown for example in FIG. 5, heating elements 26 can heat the pipe 14 to the necessary temperature such that liquidized reactive material (not shown) chemically reacts and bonds to the pipe 14 to produce the coated item 18. It should be noted that component 18 may be a rivet, knob, crank, screw, handle, grommet, bolt, clasp, shaft, nut, glass, or any number of objects made of a variety of materials.

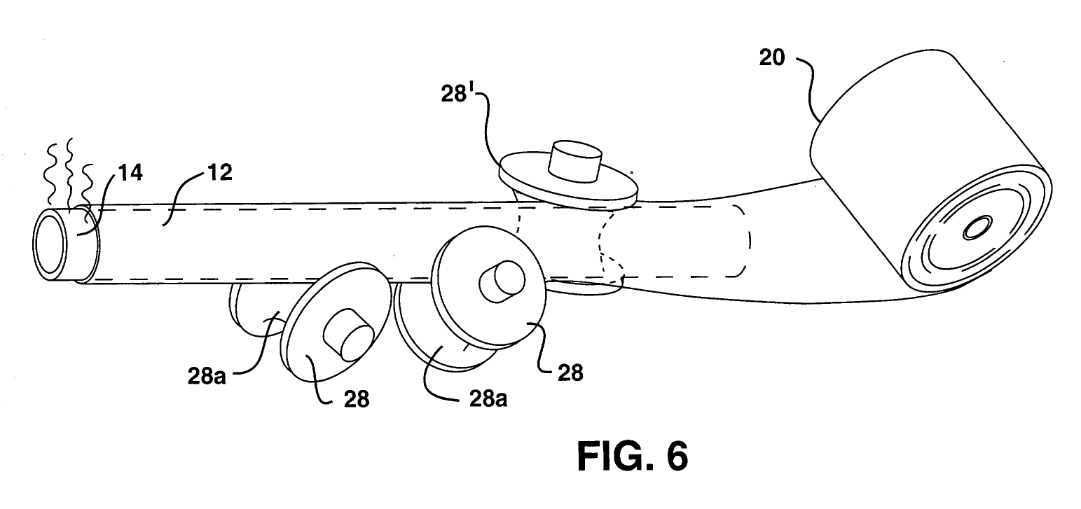

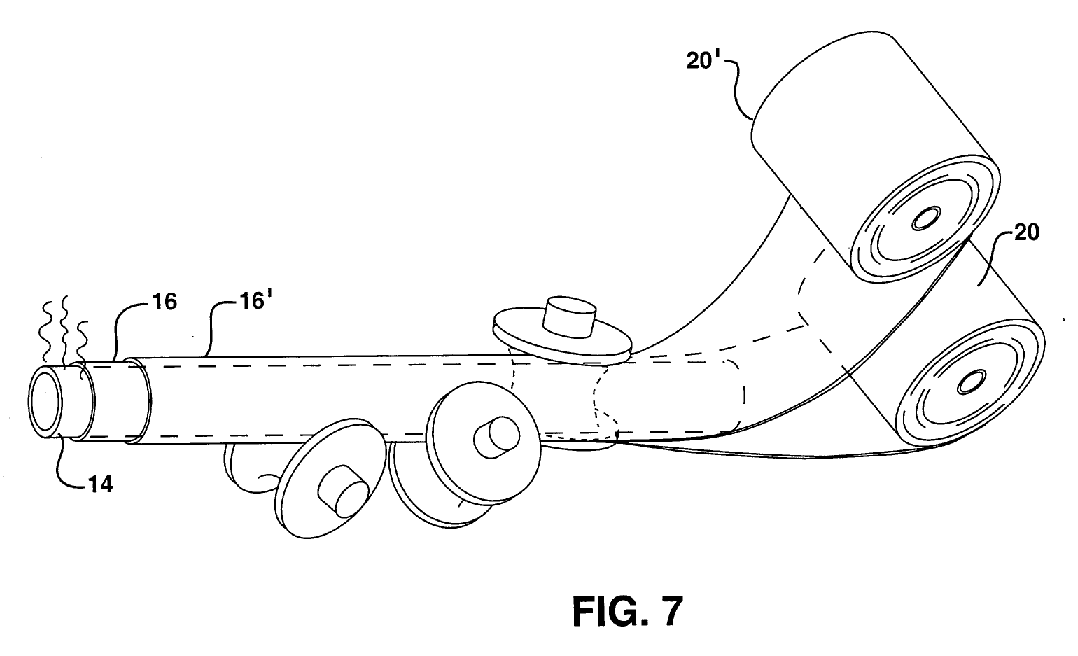

Also according to the present invention, another method for applying a reactive polymeric material to a component is depicted in FIGS. 6 and 7. As shown in FIG. 6 for example, a thin film or sheet of reactive polymeric material 20 can be wound onto the heated pipe 14 through the use of guide rollers 28. In this illustration, heated pipe 14 and press rollers 28 can maneuver the film of reactive polymeric material 20 in a manner such that it remains in continuous motion throughout the application process. By maintaining a continuous motion, reactive polymeric material 20 can be applied to multiple components in relatively little time. As a result, the process of applying a reactive material to a component can become substantially more efficient, thereby decreasing manufacturing costs.

In another aspect of the invention, FIG. 7 shows that a second film of material 20′ can be provided to coat an article 14 with a second coat of reactive polymeric material 16′ or a non-reactive material to provide greater protection. It should be understood that a second, third or multiple coats of material 16′ can be accomplished substantially at the same time that reactive material 20 is applied to heated brake line 14, or the coated brake line 12 may be reheated later to apply a second or multiple coatings for further protection. Additionally, the film 20 may define a multi-layered ribbon having, for example, a layer of reactive material overlying a layer of nylon, which overlies another reactive layer. Accordingly, this invention contemplates heating an object and applying the multi-layered ribbon to the heated object to achieve the coating step as described herein.

Optionally, another device or roller (not shown) can be provided downstream of grooved rollers 28 and lead roller 28′ to contact tubular component 14 at its bottom portion to complete the coating of tubular component 14 with reactive material 20. For instance, the present invention contemplates the use of a pulse of air or other gas to “tuck” reactive material 20 to the bottom portion of tubular component 14.

As described above, in order to coat handle 18 with reactive material 20, handle 18 can first be heated to the reactive temperature of the film of reactive polymeric material 20 so that the reactive material 20 can coat and bond to at least a portion of handle 18. Specifically, while the temperature of handle 18 in FIG. 4 is still above the reactive temperature of the reactive polymeric material 20, handle 18 can then be placed into contact with reactive material 20. Additionally, in some embodiments, this can be accomplished while the temperature of handle 18 is decreasing but still above the reactive temperature of reactive polymeric material 20.

After contacting the handle 18 with the reactive material 20, the handle 18 can then be disassociated from the continuously moving sheet of film 20. Optimally, handle 18 can be pulled away from the film of reactive polymeric material 20 so that a film layer 16 forms on a surface of handle 18. Once coated with film layer 16, the surface of handle 18 can be immediately bonded to a structurally dissimilar or similar material 22.

Alternatively, handle 18 can be cooled after being contacted with film layer 16 to form a coated article 12. The cooled film layer 16 can provide a protective coating for handle 18, or can provide an interface for future bonding to structurally dissimilar or similar materials. Because film layer 16 has already been applied to handle 18, a structurally dissimilar or similar material 22 can be easily attached to the handle 18 by simply heating either the handle 18 or the structurally dissimilar or similar material 22 at a later time.

Notably, handle 18 is depicted in FIGS. 3 and 4 as being positioned above reactive material 20 during coating, but handle 18 can also be placed in any other position capable of providing a contact area between any surface of handle 18 and reactive material 20. For instance, although not shown, handle 18 can be positioned below reactive material 20.

Also of note, pre-coated articles 12 can be readily distributed to manufacturers since pre-formed components 12 are typically not pH sensitive and need not be cleaned, in contrast to non-polymeric coated components. Accordingly, manufacturers can incorporate the components 12 in a variety of different applications by reheating components 12 when needed.

Another aspect of applying a reactive polymeric material to a material is suggested by FIG. 4. In particular, FIG. 4 may be considered to illustrate attachment of two polymeric materials in accordance with the present invention.

In general, a reactive polymeric material of the present invention can be used to attach any plastic materials known in the art. As shown, the thin film 20, of reactive polymeric material can be utilized to attach two or more plastic materials. For example, if article 18 and component 22 are considered as the two plastic materials, they may be attached together in accordance with the present invention. More specifically, if article 18 of FIG. 4 is considered to be a soft plastic component 18, it can be attached to a hard plastic component 22. Soft plastic component 18 can comprise any of a variety of plastic materials such as polyolefins, polyamides, and the like, and more particularly, polyethylene, polypropylene, or nylon. Hard plastic component 22 can also comprise any of a variety of plastic materials such as polystyrene, polycarbonate, polyvinyl alcohol, and the like.

It should be understood that the present invention is not limited to the foregoing soft and hard components, and that any plastic materials known in the art can be attached by polymeric material in accordance with the present invention. For instance, in one embodiment, two or more hard plastic components, having similar or dissimilar structures, can be attached according to the present invention.

In order to bond together two structurally dissimilar plastic components, it is typically necessary to heat the components to a temperature such that polymeric material 20 can effectively adhere to each component. For example, in one embodiment, the components can be heated to a temperature above 300° F.

Generally, a variety of methods can be utilized to expose the polymeric material 20 to a sufficient temperature to bond together structurally dissimilar plastic components. For instance, in one embodiment, the material 20 can adhere two plastic components together while the components are being heated. Furthermore, the components can be bonded together with the reactive polymeric material 20 by spin welding, ultrasonic welding, hot plates, etc.

Referring to FIG. 5, an exemplary application of the thin film of reactive polymeric material 20 to a component 14 is illustrated. In particular, an extrusion method is depicted for applying reactive material 20 to a tubular component 14. Although this example illustrates a method for applying of a reactive material to a tubular component 14, it should be understood that the method can similarly be applied to differently shaped components as well. Moreover, it should also be understood that the exemplary embodiment depicted in FIG. 5 is but one suitable method for applying a coating of reactive material onto a tubular component 14, and that various other methods are equally suitable to coat tubular components 14, as well as components having other shapes, in accordance with the present invention.

Referring again to FIG. 6, another example of coating a tubular component 14 with the thin film of reactive polymeric material 20 is depicted. Guide rollers 28 can be provided to maintain continuous motion of reactive material 20 throughout the application process. Moreover, tubular component 14 can also be maneuvered in a certain direction to facilitate coating of reactive material 20 thereon. The maneuvering of tubular component 14 can be accomplished by any of a variety of mechanisms well known in the art for moving components, such as tubular components.

With more particular reference to FIG. 6, as tubular component 14 is maneuvered, it can communicate with various devices, such as rollers 28, pulses of air or other gases (not shown), etc., that are configured to coat tubular component 14 with reactive material 12. As FIG. 6 illustrates, an aspect of the present invention includes a lead roller 28′ that can be positioned so as to contact reactive material 20 to tubular component 14. In particular, lead roller 28′ can depress reactive material 20 onto tubular component 14 as the tube 14 moves in a certain direction.

After contacting lead roller 28′, another aspect of the present invention can also include various other devices used to sufficiently coat the remaining portions of tubular component 40. For example, as shown in FIG. 6, grooved rollers 28 can be provided to coat the side portions and/or bottom portions of tubular component 14. In this embodiment, each grooved roller 28 can be formed with a grooved portion 28a that is designed to wrap reactive material 20 around a tube-shaped component 14.

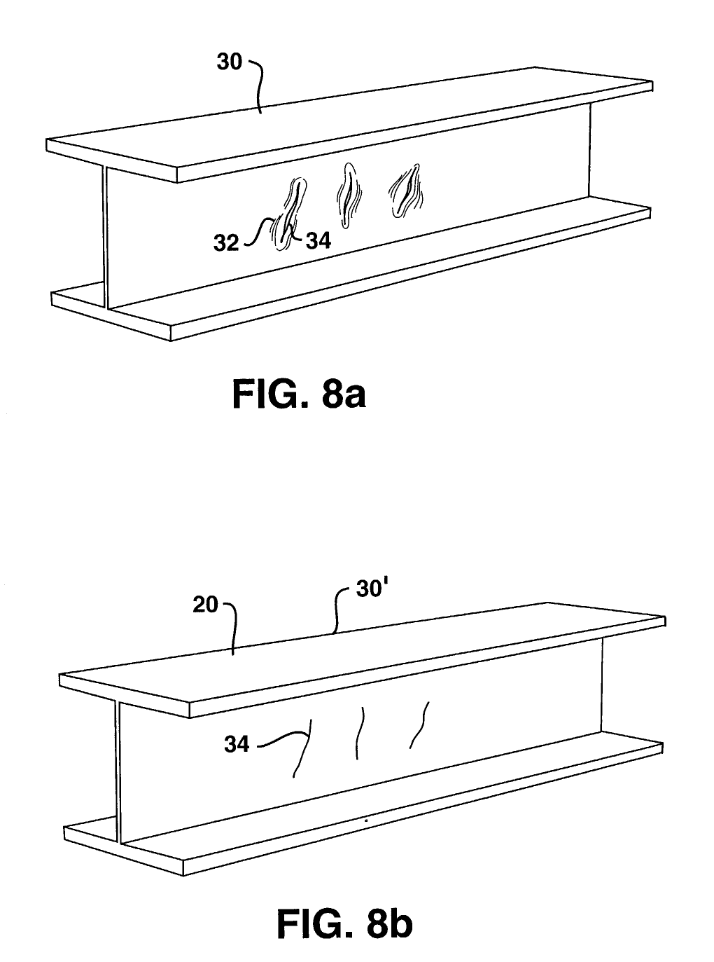

An advantage of the present invention is illustrated in FIGS. 8a and 8b in which 8a shows a structure 30 with abrasions 32. Moisture (not shown) has permeated the abrasions 32 resulting in a corrosion 34. In contrast, the chemical bonding of reactive material 20 in FIG. 8b prevents moisture from permeating scratches 32 on coated beam 30′.

Although various aspects of the invention have been described using specific terms, devices, and methods, such description is for illustrative purposes only. The words used are words of description rather than of limitation. It is to be understood that changes and variations may be made by those of ordinary skill in the art without departing from the spirit or scope of the present invention, which is set forth in the following claims. In addition, it should be understood that aspects of the various embodiments may be interchanged both in whole or in part. Therefore, the spirit and scope of the appended claims should not be limited to the description of the preferred versions contained therein.

That which is claimed is:

1. A method of coating an item with a material, the method comprising the steps of:
a) providing a metallic structure to be coated;
b) providing a film of reactive polymeric material having a polyolefin with functional monomers grafted thereto, the polyolefin capable of possessing bonding properties such that the polyolefin can chemically bond to the structure;
c) heating the structure to a temperature sufficient to activate the bonding properties of the polyolefin when the polyolefin contacts the heated structure; and
d) contacting the polyolefin with the heated structure such that the polyolefin bonds to at least a portion of the structure when the bonding properties of the polyolefin are activated to coat the structure.

2. The method of claim 1, wherein the structure is selected from the group consisting of a metallic material, a plastic, a glass, and combinations thereof.

3. The method of claim 2, wherein the structure comprises a metallic tubular structure.

4. The method of claim 3, wherein the structure is selected from the group consisting of a brake line, a fuel line, and a hydraulic line.

5. The method of claim 3, wherein the structure is an industrial gas line, the gas line configured for use in a fuel farm.

6. The method of claim 2, wherein the structure comprises a metallic fastening structure.

7. The method of claim 6, wherein the metallic fastening structure is selected from the group consisting of a bolt, a screw, a nut, a rivet, a pin, a shaft, and combinations thereof.

8. The method of claim 2, wherein the structure is selected from the group consisting of a handle, a knob, a grommet, a rod, a grip, a clip, a clasp, a crank, and combinations thereof.

9. The method of claim 2, wherein the metallic structure is selected from the group consisting of a beam, a rafter, a truss, a mainstay, a joist, and a girder, the metallic structure configured for building structures.

10. The method of claim 1, wherein the film of polyolefin has a thickness of less than about 0.010 of an inch.

11. The method of claim 10, wherein the film of polyolefin has a thickness of less than about 0.001 of an inch.

12. The method of claim 1, wherein step a includes the substep of cleaning the structure such that the bonding properties react substantially efficiently.

13. The method of claim 12, wherein the substep of cleaning includes substantially neutralizing the pH of the structure.

14. The method of claim 1, wherein the structure is heated to a temperature between about 400° Fahrenheit to about 500° Fahrenheit.

15. The method of claim 1, wherein the structure is heated to a temperature between about 4200 Fahrenheit to about 470° Fahrenheit.

16. The method of claim 1, wherein step d includes the substep of rolling the polyolefin on the structure.

17. The method of claim 1, further including the steps of cooling the coated structure to a second temperature less than the heated temperature, re-heating to a third temperature and attaching the re-heated coated structure to a second article such that the re-heated coated structure meltably adheres to the second article.

18. The method of claim 1, further including the step of attaching the heated coated structure to a second article such that the heated coated structure meltably adheres to the second article.

19. A method of coating an item with a material, the method comprising the steps of:
a) providing a structure to be coated;
b) providing a film of reactive polymeric material defining a polyolefin having functional monomers grafted thereto, the reactive polymeric material being capable of possessing bonding properties such that the reactive polymeric material can bond to the structure;
c) providing a second film of material being capable of bonding to the reactive polymeric material when the reactive polymeric material bonds to the structure;
d) heating the structure to a temperature sufficient to activate the bonding properties of the reactive polymeric material when the polymeric material contacts the heated structure;
e) contacting the reactive polymeric material with the heated structure such that the reactive polymeric material bonds to at least a portion of the structure when the bonding properties of the reactive polymeric material are activated to coat the structure; and
f) contacting the second film to the reactive polymeric material when the bonding properties of the reactive polymeric material are activated to coat the structure.

20. The method of claim 19, wherein the second film is selected from the group consisting of a reactive polymeric material, a non-reactive material, and combinations thereof.

21. The method of claim 20, wherein the non-reactive material is nylon.

22. The method of claim 19, wherein step f occurs substantially immediately after step e.

23. A method of coating an item with a material, the method comprising the steps of:
a) providing a structure to be coated;
b) providing reactive polymeric material defining a polyolefin having functional monomers grafted thereto, the reactive polymeric material being capable of possessing bonding properties such that the reactive polymeric material can chemically bond to the structure;
c) heating the structure to a temperature sufficient to activate the bonding properties of the reactive polymeric material when the polymeric material contacts the heated structure; and
d) providing a crosshead extruder to contact the reactive polymeric material to the heated structure; and
e) contacting the reactive polymeric material with the heated structure such that the reactive polymeric material bonds to at least a portion of the structure when the bonding properties of the reactive polymeric material are activated to coat the structure.

24. The method of claim 23, wherein a step for providing a roller to contact the reactive polymer's material to the heated structure is substituted for step d.

25. A method of coating comprising the steps of:
a) providing a structure to be coated;
b) providing a multi-layered material having at least one layer of reactive polymeric material with a polyolefin with functional monomers grafted thereto, and a layer of material bonded to the reactive polymeric material, the at least one layer of reactive polymeric material disposed in a direction of the structure, the polyolefin capable of possessing bonding properties such that the polyolefin can chemically bond to the structure;
c) heating the structure to a temperature sufficient to activate the bonding properties of the polyolefin when the polyolefin contacts the heated structure; and
d) contacting the polyolefin with the heated structure such that the polyolefin bonds to at least a portion of the structure when the bonding properties of the polyolefin are activated to coat the structure.

26. The method of claim 25, wherein the multi-layered material has a plurality of reactive polymeric material layers and a plurality of layers of materials.
